(19) United States
(12) Patent Application Publication
(10) Pub. No.: US 2012/0037866 A1
(43) Pub. Date: Feb. 16, 2012

(54) SAFETY STRUCTURE FOR A RAILWAY LINE

(75) Inventors: Gerardus Majella BIESBROUCK, HG Santpoort-Zuid (NL); Johannes Antonius BAKKER, RT Venlo (NL)

(73) Assignee: ROOF SAFETY SYSTEMS B.V., RT Venlo (NL)

(21) Appl. No.: 13/253,542

(22) Filed: Oct. 5, 2011

Related U.S. Application Data
(63) Continuation-in-part of application No. 13/262,090, filed on Oct. 27, 2011.

(30) Foreign Application Priority Data
Mar. 30, 2009 (NL) 2002682

(51) Int. Cl. B61K 13/00; B23P 19/00; H01F 7/04; E04H 17/20; H01F 7/02

(52) U.S. Cl. 256/14; 29/426.1

(57) ABSTRACT

Safety structure for protecting a construction including a rail extending along the construction, includes a fencing supported on supports resting on the track bed. These supports are connected to a rail. The connection is effected by a magnetic force. At their free ends, the supports are provided with permanent magnets having a shape such that they can be brought into engagement with a surface part of the rail. Due to the significant length of the supports, it is possible to apply a great torque to the magnets when the other end is engaged, that is to say that end which is turned away from the permanent magnets, as a result of which the magnet slides away along the web and can be detached therefrom. The magnet may include a number of magnets stacked on top of one another. The magnet may be slightly displaceable with respect to the support.

### CROSS REFERENCE TO RELATED APPLICATIONS

This application is a continuation-in-part of copending application Ser. No. 13/262,090 filed on Sep. 29, 2011; which is the 35 U.S.C. 371 national stage of International application PCT/NL10/50159 filed on Mar. 29, 2010; which claims priority to Netherlands application 2002682 filed Mar. 30, 2009. The entire contents of each of the above-identified applications are hereby incorporated by reference.

### BACKGROUND OF THE INVENTION

The present invention relates to a safety structure according to the preamble of claim 1.

A structure of this type is generally known in the state of the art. Examples which may be mentioned include FR 2,904,836, NL 1,030,956 and GB 2,333,795. All these structures are configured to connect the support to a rail of the railway track which is still present, due to the fact that when work is being carried out on double or multiple tracks, one railway track will generally be worked on while the other railway track will remain in use. Therefore, the railway workers will have to be protected. The only fixed points on such a railway track are the rails and sleepers. Therefore, the above-described prior art proposes a structure which engages with the rail foot or the centre sections of the rail, since the head of the rail has to remain clear for any passing trains.

NL 1 030 956 discloses a securing structure for a fence or the like which uses clamps. These clamps engage with the foot of a rail and are provided with a recess to this end. One of the clamps consists of two clamping bodies which are spaced apart and between which a magnet is arranged which comes to lie against the foot, thus locking the clamps.

WO 2007/035085 discloses a completely mechanical clamping system which is clamped between the head, the body and the foot of the rail.

This means that the fitting of such fencing is a complicated matter which takes up a considerable amount of time. The fitting and removal of fencing is a highly critical period because, at those times, the railway workers are not protected, and/or the railway traffic has to be halted completely.

It is an object of the present invention to provide an improved safety structure which can be fitted and removed in a quick and simple manner. In addition, it is an object of the present invention to provide a safety structure which can be used under all kinds of circumstances, that is to say both with structures using sleepers on a gravel bed and other kinds of structures (for example those where the sleepers are (partly) cast in or attached to a concrete slab).

This object is achieved with the above-described safety structure by the features of claim 1.

According to the present invention, magnetic force is used to attach the fencing to the respective rail of the construction. Nowadays, the permanent magnets which are commercially available are so strong that magnetic force can withstand the loads which are exerted on the fencing. These loads are mainly wind loads, either caused by storms or by passing traffic or trains, for example. Such loads act in a direction at right angles to the web of the rail, that is to say in a direction substantially parallel to the longitudinal direction of the supports for the fencing. Surprisingly, it was found that even rail sections with small dimensions have sufficient (magnetic) inductance to ensure secure attachment.

The magnetic connection between the rail and the support takes place near the web. The web or centre section of a rail offers a relatively large engagement surface for, for example, a permanent magnet.

According to the present invention, tensile force on the support, that is to say a force in the direction of moving the support away from the rail is (preferably substantially completely) absorbed by the magnet. This is in contrast with prior-art structures in which such a tensile force is absorbed by hooks situated on the opposite side of the rail.

This means that removal of the magnet and thus of the support of the rail is not possible by simply pulling thereon, that is to say applying a tensile force on the support in a direction at right angles to the longitudinal extension of the web. However, it is possible to release the connection between the support and the rail in a simple manner by tilting the end of the support upwards, away from the rail. Such a tilting movement will cause the magnet to move along the web and subsequently along the foot of the rail and will then cause the connection between the rail and the permanent magnet to be released by a sliding movement. This type of disconnection by a sliding movement can be achieved in a relatively simple manner. In addition, the support has a considerable length, so that the application of a force near its free end results in a significant torque being applied to the rail.

According to an advantageous embodiment of the invention, the magnet is composed of a number of magnet sections arranged above or next to one another. These may adjoin one another directly, but it is also possible to provide separate bodies therebetween, such as plastic material filled with magnetic material.

Preferably, the polarity of these magnet sections alternates, that is to say, viewed in the direction of the web of the rail, a succession of north/south/north/south/north/south or the other way round is produced. As a result thereof, the extent of the magnetic field in the rail is limited so that the transmission of other electromagnetic signals in or near the rail is disturbed as little as possible.

According to a further advantageous embodiment, the magnet can be displaced slightly with respect to the support. This displacement is relatively small, but makes it possible to compensate for differences in height resulting from inaccuracies, such as for example differences in height due to the presence of the gravel bed. According to a further embodiment, with the structure which is fitted with a number of magnet sections, these magnet sections can also be displaced with respect to one another. This is preferably achieved by means of a fork-like part in which said magnet or magnet sections are accommodated.

According to a further advantageous embodiment, the supports are hingedly connected to one another by means of posts. Pipes are in turn attached to these posts, thus forming the fencing. These posts can be folded in with the supports, producing a compact structure which can easily be removed and transported.

According to a particular embodiment of the present invention, the head end part comprising the magnet (magnet sections) is the only part of the support which is in contact with the rail. According to a particular embodiment of the present invention, the support is designed such that it can rest on a sleeper. By resting the support in this way, it can be ensured in the case of a series of supports that these are always exactly at the same level, as a result of which the fencing can be accurately adjusted. This prevents any irregularities in the gravel bed from causing an irregular positioning of the fencing.

The invention also relates to a method for removing a safety structure for protecting a a construction comprising a rail extending along the construction, which safety structure comprises a fencing which is upright in the position of use and provided with supports which are horizontal in the position of use, which supports can be connected to a rail by one end, said end of said supports comprising a head end part with a permanent magnet, a free contact surface of which is in contact with a surface part of a rail, in which the support is lifted at the end near the fencing, the magnet is pushed downwards along the surface part of the rail and is detached from said web.

In addition, the invention relates to a construction provided with a safety structure, comprising in a longitudinal direction of the construction one or more rails extending along the construction parallel to the longitudinal direction, wherein the safety structure comprises a fencing which is upright in the position of use and provided with supports which are horizontal in the position of use, which supports can be connected to one of said rails by one end, said end of said support comprising a permanent magnet, a free contact surface which is in contact with a surface part of said rail.

In addition, the invention relates to a construction of a railway provided with a safety structure, comprising a railway track constructed on a bed and consisting of sleepers and spaced-apart rails, wherein each rail comprises a head, web and foot, in which the safety structure comprises a fencing which is upright in the position of use and provided with supports which are approximately horizontal in the position of use, which supports can be connected to one of said rails by one end, said end of said support comprising a permanent magnet, a free contact surface of which is in contact with the web of said rail.

Additionally, the invention relates to a construction of a crashbarrier provided with a safety structure, comprising a track constructed on a bed and comprising one or more crashbarrier rails, wherein the safety structure comprises a fencing which is upright in the position of use and provided with supports which are horizontal in the position of use, which supports can be connected to one of said rails by one end, said end of said support comprising a permanent magnet, a free contact surface which is in contact with a surface part of said rail.

The invention will be described in more detail below with reference to an exemplary embodiment illustrated in the drawing, in which:

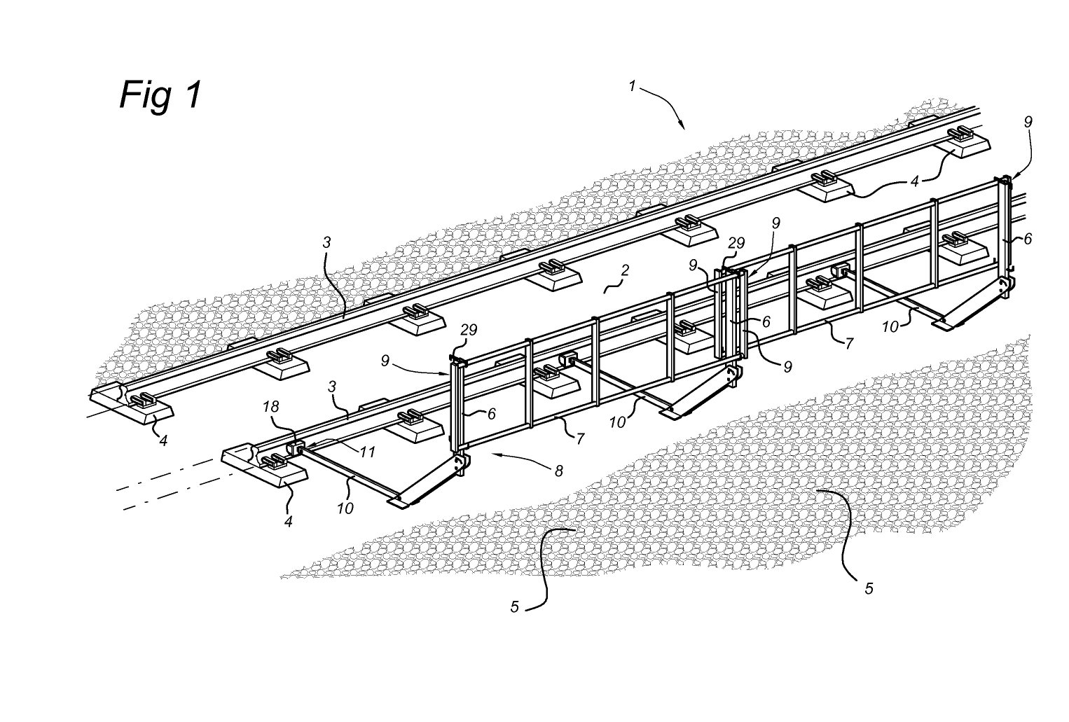

FIG. 1 shows a railway line provided with the safety structure according to the invention;

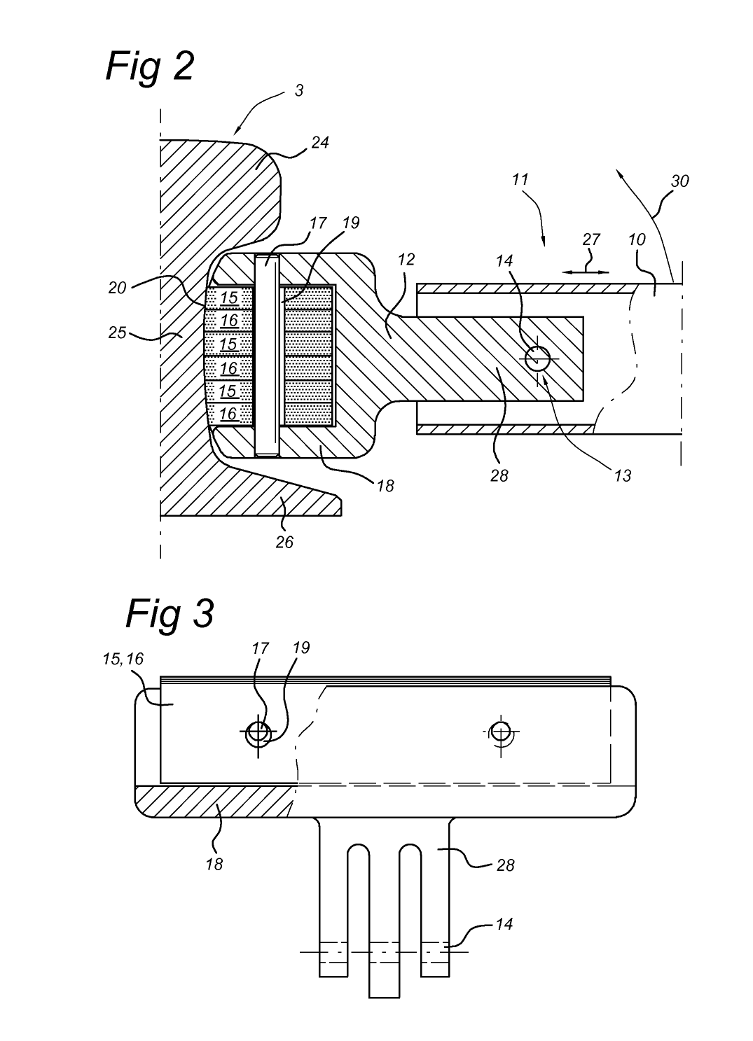

FIG. 2 shows a partial cross section in side view of a detail of the safety structure;

FIG. 3 shows a top view of the detail from FIG. 2;

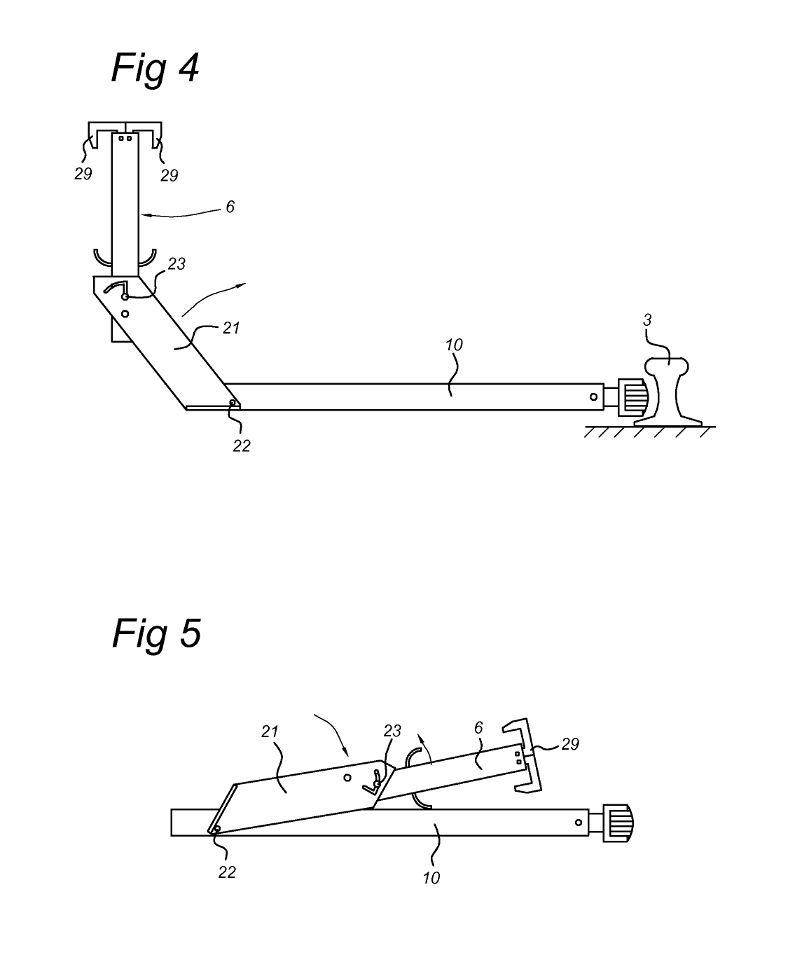

FIG. 4 shows a side view of the combination of the support and post in the folded-out position;

FIG. 5 shows the combination from FIG. 4 in the folded-in position; and

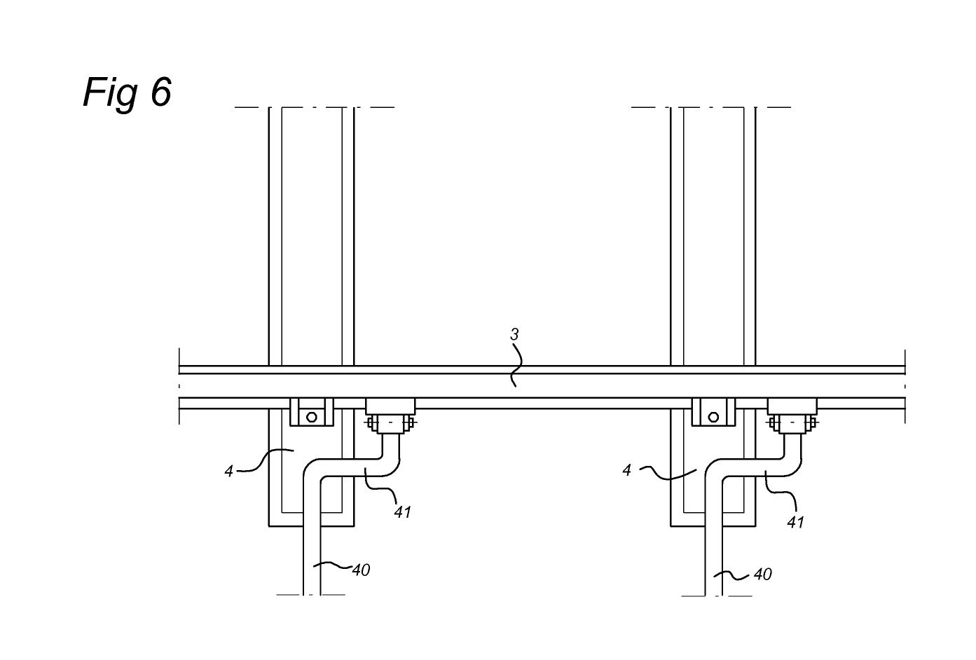

FIG. 6 shows a top view of a variant of the above-described support.

FIG. 1 shows a railway line consisting of a railway track 1 on which no work is being carried out. This railway track 1 comprises a bed 2 with two spaced-apart rails 3 arranged thereon which are connected to one another via sleepers 4. Reference numeral 5 denotes the zone situated next to the railway track 1. This may be a road or another civilian structure, but will generally be a further railway track, with maintenance having to be carried out on said railway track 5 (not shown). Rail 3 consists of a head 24, web 25 and foot 26.

If the railway track 1 remains in use, the safety of the workers must be ensured under all circumstances. To this end, a fencing 9 consisting of longitudinal pipes 7 coupled to posts 6 is provided to form the fencing 9. The posts 6 are connected to supports 10 by means of hinges 22 and 23 which are to be described below with reference to FIGS. 4 and 5. The supports 10 are attached to the web 25 of rail 3 by means of permanent magnets, as can be seen in FIG. 2. FIG. 2 shows how the end 11 of support 10 is provided with a fork-like part 12 near the rail 3. The stem 28 of this fork-like part is

1. Safety structure (8) for shielding a construction comprising a rail extending along the construction, comprising a fencing (9) which is upright in the position of use and provided with supports (10) which are horizontal in the position of use, which supports can be connected to a rail (3) by one end (11), which end (11) comprises a permanent magnet with a free surface (20) for contacting a rail, characterized in that said end (11) comprises a head end part having said magnet (15), said head end part being embodied to contact the web part (25) of a rail (3), the contact surface of said end part (18) comprising the free surface of said magnet (15), said magnet (15) being provided for absorbing tensile forces exerted in a direction at right angles to said contact surface.

2. Safety structure according to claim 1, wherein said magnet (15) is hingedly (13) connected to said support.

3. Safety structure according to claim 1, wherein said magnet comprises a number of magnet sections (15) which are situated above one another in the position of use.

4. Safety structure according to claim 3, wherein said magnet sections can be displaced with respect to said support.

5. Safety structure according to claim 4, wherein said magnet sections can be displaced with respect to one another in the longitudinal direction (27) of said support.

6. Safety structure according to claim 3, wherein metal-filled plastic parts (16) are present between said magnet sections.

7. Safety structure according to claims 3, wherein one of the magnet sections (15) is provided with an opening (19), through which a pin (17) extends, having a substantially smaller diameter than the diameter of said opening in order to make it possible to displace said magnet section.

8. Safety structure according to claim 3, wherein the front surface (20) of said magnet sections corresponds to the shape of the web of a rail (3).

9. Safety structure according to claim 1, wherein said magnet is accommodated in a fork-like part (12), in which the stem (28) of said part is hingedly connected to said support (10).

10. Safety structure according to claim 1, wherein said support (10) is attached to said fencing by means of a lockable hinge (22, 23).

11. Safety structure (8) according to claim 1, wherein said contact surface is at least 5 cm high and 10 cm long.

12. Safety structure according to claim 1, wherein the construction is a railway line and said support (10) is embodied to be supported on a railway sleeper (4).

13. Method for removing a safety structure for shielding a construction comprising a rail extending along the construction, said safety structure comprising a fencing which is upright in the position of use and provided with supports (10) which are horizontal in the position of use, said supports being connectable to a rail by one end, said end of said supports comprising a head end part with a permanent magnet, a free contact surface of which is in contact with a surface part of a rail, wherein the support (10) is lifted at the end near the fencing, the magnet (15) is pushed downwards along the surface part of a rail and is detached from said web.

14. Construction provided with a safety structure, comprising in a longitudinal direction of the construction one or more rails extending along the construction parallel to the longitudinal direction, wherein the safety structure comprises a fencing which is upright in the position of use and provided with supports (10) which are horizontal in the position of use, which supports can be connected to one of said rails by one end, said end of said support comprising a permanent magnet, a free contact surface which is in contact with a surface part of said rail.

15. Railway (11) provided with a safety structure, comprising a railway track (1) constructed on a bed (2) and consisting of sleepers (4) and spaced-apart rails, in which each rail (3) comprises a head (24), web (25) and foot (26), wherein the safety structure comprises a fencing which is upright in the position of use and provided with supports (10) which are horizontal in the position of use, which supports can be connected to one of said rails (3) by one end, said end of said support comprising a permanent magnet, a free contact surface which is in contact with the web of said rail.

16. Crashbarrier provided with a safety structure, comprising a track constructed on a bed and comprising one or more crashbarrier rails, wherein the safety structure comprises a fencing which is upright in the position of use and provided with supports (10) which are horizontal in the position of use, which supports can be connected to one of said rails by one end, said end of said support comprising a permanent magnet, a free contact surface which is in contact with a surface part of said rail.

17. Safety structure according to claim 2, wherein said magnet comprises a number of magnet sections (15) which are situated above one another in the position of
